(19) United States
(12) Patent Application Publication
(10) Pub. No.: US 2020/0031678 A1
(43) Pub. Date: Jan. 30, 2020

(54) LOW-FREQUENCY IMPROVEMENT MATERIAL AND SPEAKER SYSTEM USING SAME

(71) Applicant: AAC ACOUSTIC TECHNOLOGIES (SHENZHEN) CO., LTD., Shenzhen (CN)

(72) Inventors: Hongshu Feng, Shenzhen (CN); Hezhi Wang, Shenzhen (CN); Jiqiang Dai, Shenzhen (CN); Kun Tang, Shenzhen (CN)

(21) Appl. No.: 16/522,699

(22) Filed: Jul. 26, 2019

(30) Foreign Application Priority Data
Jul. 28, 2018 (CN) 201810849780.5

(51) Int. Cl. C01B 39/02; C01B 39/46; H04R 1/02; H04R 1/28

(52) U.S. Cl. CPC C01B 39/023; C01B 39/46; H04R 1/025; C01P 2002/72; C01P 2002/60; C01P 2004/61; C01P 2004/03; H04R 1/2811

(57) ABSTRACT

The present disclosure provides an low-frequency improvement material. The low-frequency improvement material comprises a plurality of zeolite particles which comprises a plurality of zeolite grains, the zeolite grains comprises a plurality of zeolite crystallites, the zeolite crystallite comprises frameworks and extra-framework cations, the skeleton comprises SiO2 and MxOy containing element M, the average crystalline size of the zeolite crystallite ranges from 5 nm to 75 nm. The present disclosure also provides the low frequency speaker system improved materials applications. Improving material of the present disclosure provides low frequency and low frequency applications the material is improved speaker system can further improve the performance of the speaker system, the molecular sieve to reduce failure, improve performance stability Ascension speaker system.

### FIELD OF THE DISCLOSURE

The present disclosure relates to a low-frequency material, and more particularly to an improvement material applied in low-frequency acoustic-electro transducers and speaker system using the same.

### DESCRIPTION OF RELATED ART

With the development of science and technology and improvement of living standards, people have higher and higher requirements for the performance of the speaker system. In particular, for a speaker system of the mobile phone, it is required to provide excellent acoustic performance minimizing the volume. Since the volume of electronic products becomes more and more compact, the volume of the cavity for receiving the speaker system is being smaller and smaller. There provides some low-frequency improved material, such as activated carbon, zeolite and so on to increase the virtual volume of the posterior cavity and improve the response of the speaker system in low frequency band.

However, it becomes deteriorated for the performance of the low-frequency improvement material due to the fact that the speaker system emits a small amount of various types of VOCs in actual environment. At the same time, it becomes more and more difficult to predict and control for various types of VOCs emitting from the speaker system and the amount of each types of VOCs with the integration of electronic products is being more and more high, and the system of the electronic products is being more and more complex, so the environmental stability requirements of resistant material complex VOCs for low-frequency improvement materials are required is being more and more demanding.

Therefore, it is desired to provide new and improvement low-frequency materials and low-frequency speaker system using the same to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a topographical view of a zeolite grain with an MFI structure of a low-frequency improvement material disclosed by a first preferred embodiment of the present disclosure under a scanning electron microscope;

FIG. 2 is an XRD pattern corresponding to the low-frequency improvement material disclosed in the first preferred embodiment of the present disclosure;

FIG. 3 is a topographical view of a zeolite grain with an MFI structure of a low-frequency improvement material disclosed by a second preferred embodiment of the present disclosure under a scanning electron microscope;

FIG. 4 is an XRD pattern corresponding to the low-frequency improvement material disclosed in the second preferred embodiment of the present disclosure;

FIG. 5 is a topographical view of a zeolite grain with an MFI structure of a low-frequency improvement material disclosed by a third preferred embodiment of the present disclosure under a scanning electron microscope;

FIG. 6 is an XRD pattern corresponding to the low-frequency improvement material disclosed in the third preferred embodiment of the present disclosure;

FIG. 7 is a topographical view of a zeolite grain with an MFI structure of a low-frequency improvement material disclosed by a forth preferred embodiment of the present disclosure under a scanning electron microscope;

FIG. 8 is an XRD pattern corresponding to the low-frequency improvement material disclosed in the forth preferred embodiment of the present disclosure;

FIG. 9 is a topographical view of a zeolite grain with an MFI structure of a low-frequency improvement material disclosed by a fifth preferred embodiment of the present disclosure under a scanning electron microscope;

FIG. 10 is an XRD pattern corresponding to the low-frequency improvement material disclosed in the fifth preferred embodiment of the present disclosure;

FIG. 11 is a topographical view of a zeolite grain with an MFI structure of a low-frequency improvement material disclosed by a sixth preferred embodiment of the present disclosure under a scanning electron microscope;

FIG. 12 is an XRD pattern corresponding to the low-frequency improvement material disclosed in the sixth preferred embodiment of the present disclosure;

FIG. 13 is a topographical view of a zeolite grain with an MFI structure of a low-frequency improvement material disclosed by a seventh preferred embodiment of the present disclosure under a scanning electron microscope;

FIG. 14 is an XRD pattern corresponding to the low-frequency improvement material disclosed in the seventh preferred embodiment of the present disclosure;

FIG. 15 is a topographical view of a zeolite grain with an MFI structure of a low-frequency improvement material disclosed by a eighth preferred embodiment of the present disclosure under a scanning electron microscope;

FIG. 16 is an XRD pattern corresponding to the low-frequency improvement material disclosed in the eighth preferred embodiment of the present disclosure;

FIG. 17 is a topographical view of a zeolite grain with an MFI structure of a low-frequency improvement material disclosed by a ninth preferred embodiment of the present disclosure under a scanning electron microscope;

FIG. 18 is an XRD pattern corresponding to the low-frequency improvement material disclosed in the ninth preferred embodiment of the present disclosure;

FIG. 19 is a topographical view of a zeolite grain with an MFI structure of a low-frequency improvement material disclosed by a tenth preferred embodiment of the present disclosure under a scanning electron microscope;

FIG. 20 is an XRD pattern corresponding to the low-frequency improvement material disclosed in the tenth preferred embodiment of the present disclosure;

FIG. 21 is a topographical view of a zeolite grain of an MFI structure material of a low-frequency improved material disclosed by the related art under a scanning electron microscope; and

FIG. 22 is a schematic diagram of the structure of the speaker system of the present disclosure.

### DETAILED DESCRIPTION

The present disclosure will be hereinafter be described in detail below with reference to the attached drawings and embodiments thereof.

The present disclosure relates to a low-frequency improvement material, which comprises a plurality of zeolite particles. The zeolite particles comprise a plurality of zeolite grains. The zeolite grains comprise a plurality of zeolite crystallites. The zeolite crystallites comprise frameworks and extra-framework cations. The skeleton comprises SiO₂ and MxOy containing element M, wherein the element M comprises an aluminium element. The extra-framework cation is at least one of hydrogen ion, alkali ion or alkaline earth metal. The average crystalline size of the zeolite crystallite ranges from 5 nm to 75 nm, wherein the molar ratio of Si/M atoms in the skeleton is more than 80.

Compared with the relevant art, for the low-frequency improvement material of the present disclosure, since the zeolite particles is ultimately composed of zeolite crystallites having uniformly distributed micro-porous structure, and the micro-pores under the acoustic pressure is used for absorbing and desorbing the attached air molecules. The micro-porous structure of the zeolite crystallites can play a role in increasing the volume of the virtual acoustic cavity, while filling the zeolite crystallites having a plurality of uniform micro-pores in the posterior cavity, it can significantly improve the low-frequency effect of the speaker system and improve the low-frequency performance. Since the zeolite particles are mainly composed of zeolite crystallites with smaller average crystallite size, the smaller the average crystallite size, the more pores the micro-pores of the zeolite particles have, correspondingly, the larger the outer surface area of the zeolite particles, and the shorter the diffusion path of the zeolite particles spread. When the same amount of organic matter is absorbed, the smoothness of the pores of the zeolite particles consisting mainly of zeolite crystallites is less affected. Thereby exhibiting stronger VOCs resistance, and the long-term stability in the speaker system is remarkably enhanced.

Specifically, in this embodiment, The Si/M atom molar ratio is preferably between 100 to 2000, more preferably between 120 to 1000, and further preferably between 140 to 800.

More importantly, the low-frequency improvement material is mainly composed of zeolite particles, zeolite particles are mainly composed of zeolite grains (zeolite original powder), usually the zeolite original powder is not a complete single crystal, but a polycrystal formed by the accumulation of many smaller crystallites (zeolite crystallites).

In the low-frequency improvement material of the present disclosure, the average crystallite size of the zeolite crystallite is between 5 nm and 75 nm, which makes the glue resistance of the zeolite particles significantly improve, thereby significantly increasing the VOCs resistance of the low-frequency improvement material and the long-term stability in the speaker system.

Specifically, in this embodiment, the average crystallite size of the zeolite crystallite is between 5 nm and 75 nm, preferably between 15 nm and 55 nm, and more preferably between 20 nm and 50 nm. The smaller the crystallite size of the zeolite crystallite in the above range, the more obvious the stability of the zeolite particles is improved.

In addition to controlling the average crystallite size of the zeolite crystallites, for the low-frequency improvement material of the present disclosure, the average grain size of the zeolite grains ranges from 10 nm to 10 μm, and more preferably ranging from 20 nm to 8 μm; Between 40 nm and 6 um; between 400 nm and 6 um; between 40 nm and 400 nm.

Since the size of the zeolite original powder is too small, it should not be directly used as a low-frequency improvement material in the speaker system to avoid the vocal monomer entering the speaker system and affecting its acoustic performance. It is usually necessary to form zeolite particles of a certain size and shape by a specific molding method. In addition to the zeolite original powder, a certain amount of solvent, binder, additives, etc. must be added in the molding process. After molding, the zeolite original powder accounts for more than 75 wt. % of the, preferably more than 85 wt. %, and more preferably more than 90 wt. % of the total solid content. The binder accounts for no more than 25%, preferably less than 15%, more preferably less than 10% of the total solid content. The solid content is not more than 5% of the total solid content.

Wherein, the specific molding methods include, but are not limited to, the ball granulation method, the spray granulation method, the post-squeezing method, the post-spinning method, the ultrasonic atomization granulation, and the like.

Wherein the “certain size” means that the size of the zeolite particles after molding ranges from 10 um to 1000 um, preferably from 20 um to 600 um, further preferably from 25 um to 450 um, more preferably from 30 um to 200 um. After the low-frequency improvement material is formed, that is, the particles formed after the zeolite original powder is molded, when used in a speaker system, the low-frequency improvement material is filled with multi-particles.

In order to maximize the low-frequency improvement effect of the zeolite original powder, the molding size range is determined according to the original powder particle size, post-forming bulk density, and molding method, Specifically as follows:

Wherein the molding shape includes spherical particles, irregular polyhedral particles, clover shape and so on, but is not limited thereto.

Wherein the solvent includes water, methanol, ethanol, tert-butanol, and so on, but is not limited thereto.

Wherein the binder comprises at least one of an inorganic binder or an organic binder. The inorganic binder includes silica sol, silica aerogel, aluminum sol, sodium silicate, potassium silicate, silicic acid, etc.;

Wherein the organic binder includes polyurethane binder, polyacrylate binder, ring Oxygen binders, etc.

Wherein the zeolite particles are a mixed phase of an MFI structure and an MEL structure, the Si/Al molar ratio is between 140 and 800, and the zeolite grains (zeolite original powder) have a particle size between 400 nm and 6 μm.

In addition, the element M of the skeleton may further include trivalent ions and/or tetravalent ions other than Al (aluminum). In this embodiment, the trivalent ion and/or tetravalent ion further includes B (boron) ion, Ga (gallium) ion, P (phosphorus) ion, Fe (iron) ion, Co (cobalt) ion, Mo (Molybdenum) One or more of ions, Ti (titanium) ions, Zr (zirconium) ions, and Ge (germanium) ions. It will be understood by those skilled person in the art that the types of trivalent ions and tetravalent ions are not limited to the above examples, and may be other ions, and do not affect the effects of the present disclosure.

It is worth mentioning that, in the present embodiment, the zeolite crystallites include at least one of an MFI structure, an MEL structure, a FER structure, a BEA structure, and a CHA structure, preferably an MFI structure, an MEL structure or a CHA structure. That is, the zeolite particles may be pure phase MFI molecular sieves. Because of the high purity of the pure phase molecular sieves, the speaker system of the zeolite particle molecular sieve filled with the MFI structure in the posterior cavity has better acoustic performance in the low frequency band. The zeolite particles may also be a mixed phase MFI molecular sieve containing other hetero phases such as MEL, BEA, etc., without affecting the effects of the present disclosure.

The extra-framework pairing cations mainly include: H+, Li+, Na+, K+, Rb+ of the alkali metal group ions, Be2+, Mg2+, Ca2+, Sr2+, Ba2+ of the alkaline earth metal group, Cu2+, Fe3+, Ag+, Au+, Zn2+ in the excessive metal. And at least one of NH4+ ammonium groups, but is not limited thereto.

The following will be combined with specific embodiments to explain the embodiment of the present disclosure.

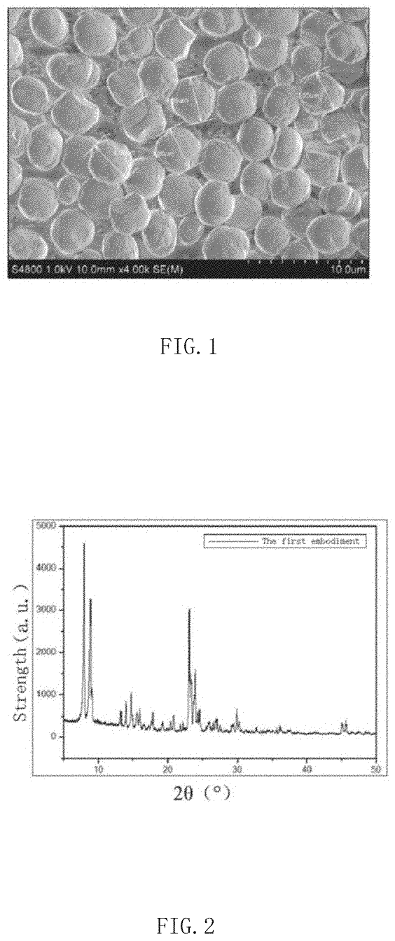

In the first preferred embodiment of the present disclosure, the low-frequency improvement material of the disclosure, the zeolite grains of the MFI structure (the zeolite crystallite of MFI large crystallites) are synthesized with silicon source, aluminum source (element M source), alkali source, template agent and water, and the average size of the zeolite crystallite of the MFI structure is 78±3 nm. Wherein the template agent is positive butamine, hexamine, diamine, ammonium tetrapropylene bromide, ammonium tetrapropylene, ammonium tetrapropylene, ammonium tetrapropylene iodide and ammonium tetrapropylene. The shape of the zeolite grains with its MFI structure is shown in FIG. 1, and the XRD standard pattern is shown in FIG. 2. Among them, as shown in FIG. 1, zeolite grains have dimensions: 3.65 um, 3.86 um, 4.05 um.

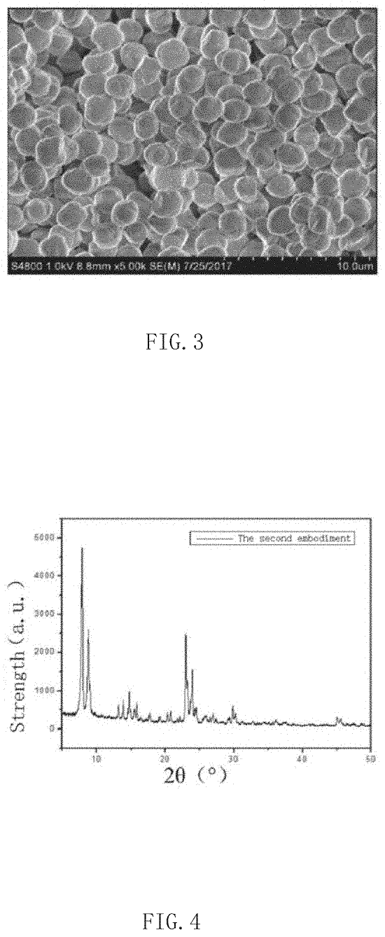

In the second preferred embodiment of the present disclosure, the low-frequency improvement material of the disclosure, the zeolite grains of synthetic MFI structure are changed on the basis of the first embodiment, and the average size of the Zeolite crystallite of the MFI structure is 53±2 nm. The shape of the zeolite grains with its MFI structure is shown in FIG. 3, and the XRD standard pattern is shown in FIG. 4.

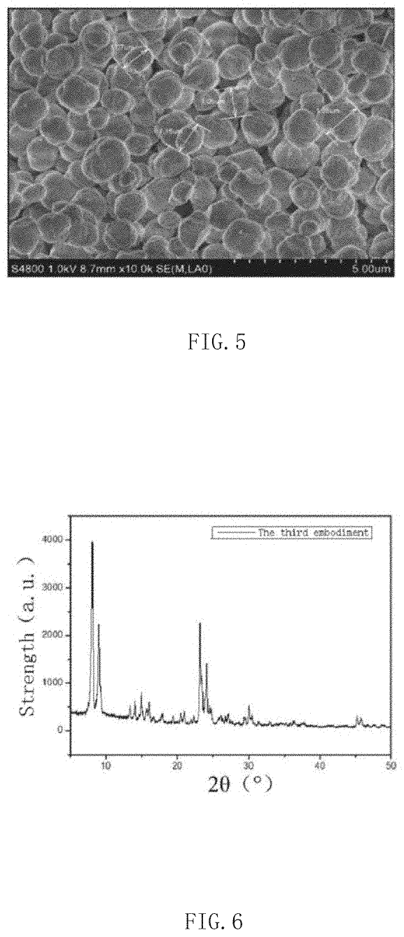

In the third embodiment of the low-frequency improvement material of the present disclosure, the zeolite grains of synthetic MFI structure are changed on the basis of first embodiment, and the average size of the zeolite crystallite of the MFI structure is 40±2 nm. The shape of the zeolite grains with its MFI structure is shown in FIG. 5, and the XRD standard pattern is shown in FIG. 6. Among them, as shown in FIG. 5, zeolite crystallites have sizes: 1.05 um, 1.07 um, 1.15 um, 1.35 um.

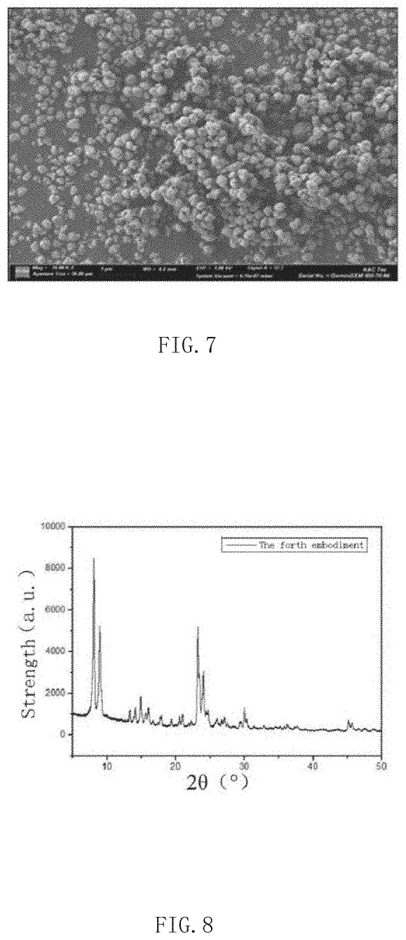

In the fourth embodiment of the low-frequency improvement material of the present disclosure, the zeolite grains of synthetic MFI structure are changed on the basis of the first embodiment, and the average size of the zeolite crystallite of the MFI structure is 34±3 nm. The shape of the zeolite grains with its MFI structure is shown in FIG. 7, and the XRD standard pattern is shown in FIG. 8.

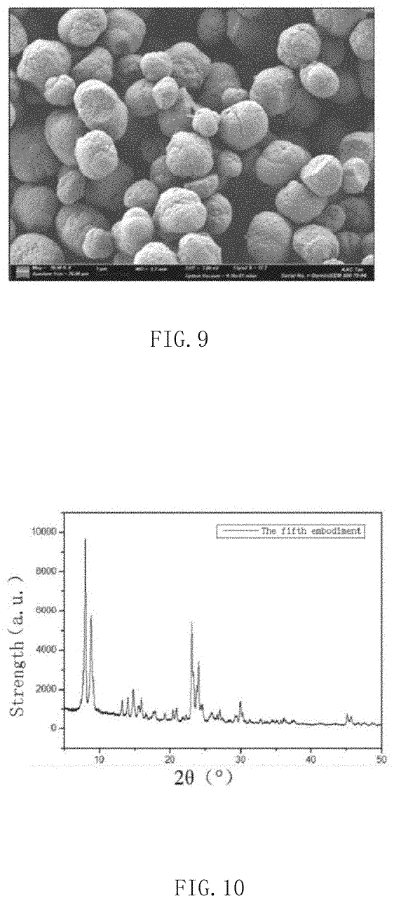

In the fifth embodiment of the low-frequency improvement material of the present disclosure, the zeolite grains of synthetic MFI structure are changed on the basis of the first embodiment, and the average size of the zeolite crystallite of the MFI structure is 40±2 nm. The shape of the zeolite grains with its MFI structure is shown in FIG. 9, and the XRD standard pattern is shown in FIG. 10.

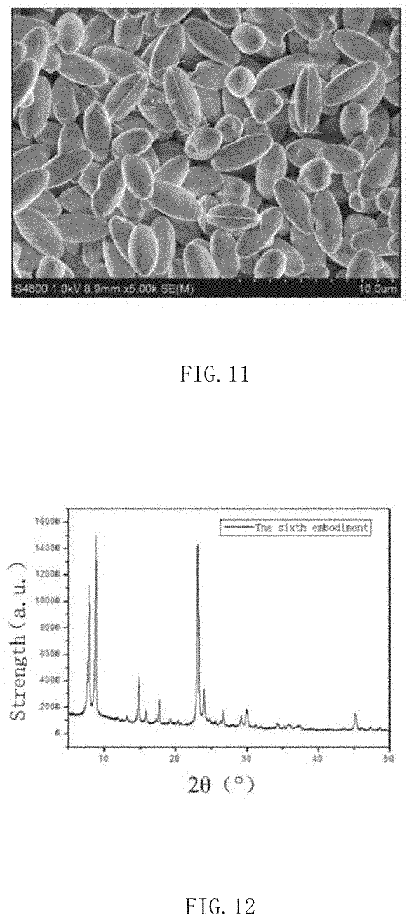

In the sixth embodiment of the low-frequency improvement material of the present disclosure, the zeolite grains of synthetic MFI structure are changed on the basis of the first embodiment, and the average size of the zeolite crystallite of the MFI structure is 58±2 nm. The shape of the zeolite grains with its MFI structure is shown in FIG. 11, and the XRD standard pattern is shown in FIG. 12. Among them, as shown in FIG. 11, zeolite crystallites have sizes: 3.68 um, 3.97 um, 4.45 um, 4.47 um.

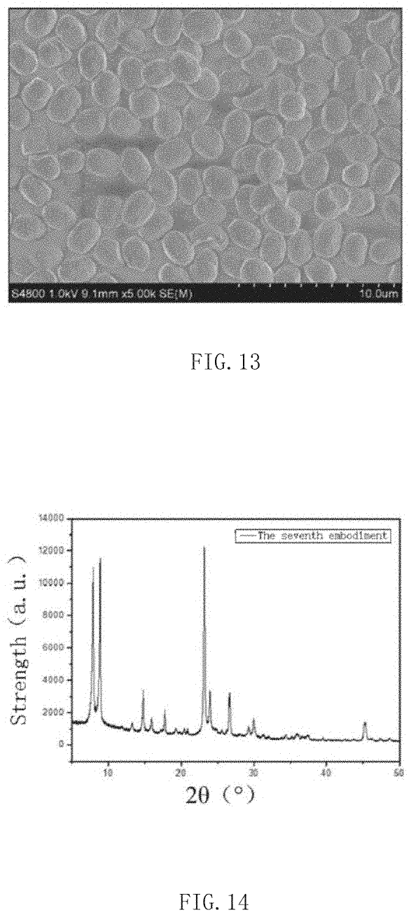

In the seventh embodiment of the low-frequency improvement material of the present disclosure, the zeolite grains of synthetic MFI structure are changed on the basis of the first embodiment, and the average size of the zeolite crystallite of the MFI structure is 54±2 nm. The shape of the zeolite grains with its MFI structure is shown in FIG. 13, and the XRD standard pattern is shown in FIG. 14.

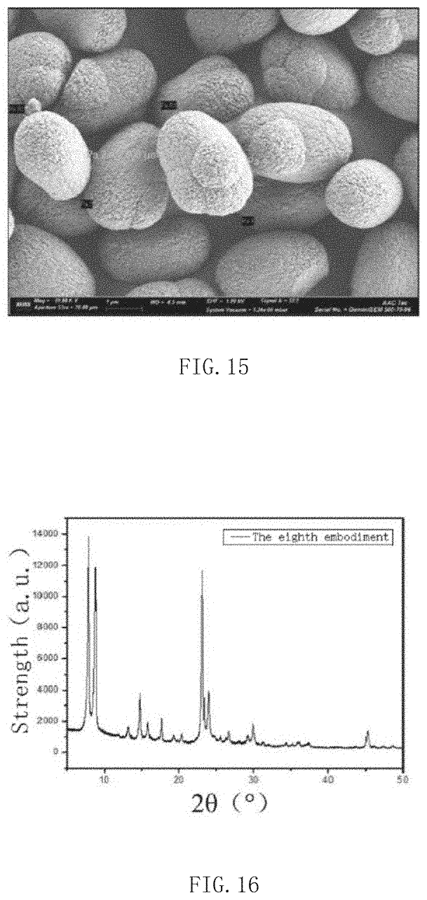

In the eighth embodiment of the low-frequency improvement material of the present disclosure, the zeolite grains of synthetic MFI structure are changed on the basis of the first embodiment, and the average size of the zeolite crystallite of the MFI structure is 43±2 nm. The shape of the zeolite grains with its MFI structure is shown in FIG. 15, and the XRD standard pattern is shown in FIG. 16. Among them, as shown in FIG. 15, zeolite crystallites have sizes: 2.5 um, 1.07 um, 3.12 um.

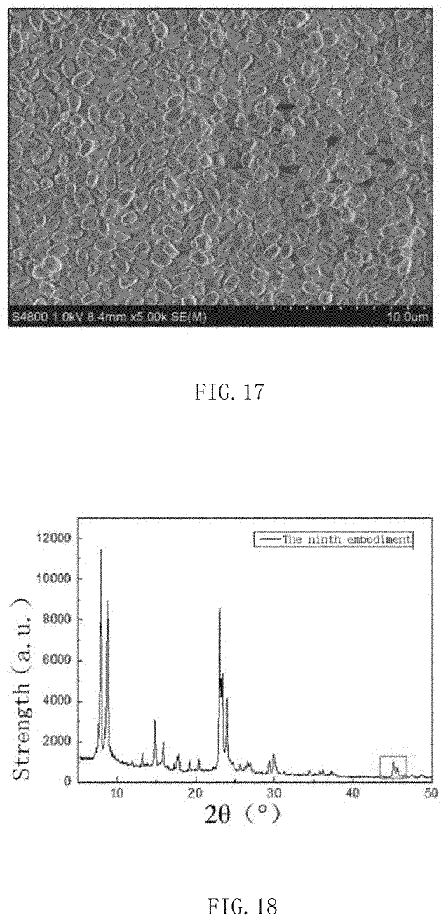

In the ninth embodiment of the low-frequency improvement material of the present disclosure, the zeolite grains of synthetic MFI structure are changed on the basis of the first embodiment, and the average size of the zeolite crystallite of the MFI structure is 55±2 nm. The shape of the zeolite grains with its MFI structure is shown in FIG. 17, and the XRD standard pattern is shown in FIG. 18.

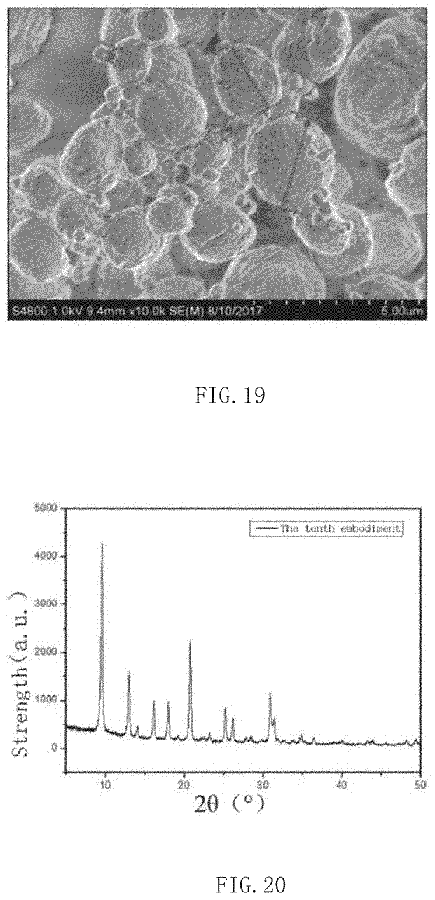

In the tenth embodiment of the low-frequency improvement material of the present disclosure, the zeolite grains of synthetic MFI structure are changed on the basis of the first embodiment, and the average size of the zeolite crystallite of the MFI structure is 70±3 nm. The shape of the zeolite grains with its MFI structure is shown in FIG. 19, and the XRD standard pattern is shown in FIG. 20. Among them, as shown in FIG. 15, zeolite crystallites have sizes: 481 nm, 449 nm, 2.24 um, 2.87 um.

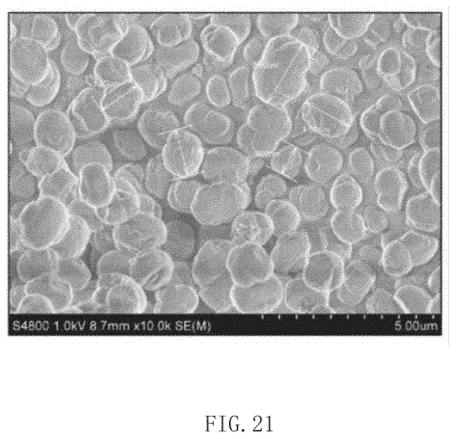

In one embodiment of the related art, the processing method of the present low-frequency improvement material, on the basis of the first embodiment of the present disclosure, the zeolite grains of the MFI structure were synthesized under the synthetic conditions, and the average zeolite crystallite size of the MFI structure was 55±2 nm. The topographical view of the zeolite grains of the MFI structure is shown in FIG. 21. As shown in FIG. 21, the zeolite grains have dimensions of 892 nm, 1.3 um, 1.41 um, 1.5 um, and 2.02 um.

The zeolite grains synthesized in the embodiment 1-10 of the present disclosure and the related art embodiment are separately mixed with a solvent, a binder and an auxiliary agent to prepare a suspension mixture, which is dried and pulverized to obtain granulated zeolite granules, and the zeolite granules are placed after molding. After the high temperature of the speaker system coexisted for 48 hours, the VOCs were tested for low frequency improvement performance before and after coexistence.

Long-term stability evaluation conditions: The speaker system products with low-frequency improvement materials were placed in an environmental test chamber, and the high-temperature and high-humidity load was operated for 200 hours. The acoustic performance difference before and after the test was tested, and the results are shown in Table 1.

TABLE 1
Reduction of the resonant frequency F0 before and after the addition
of zeolite particles in the posterior cavity of the speaker system

| | | | | | Low-frequency | Low-frequency |
|---|---|---|---|---|---|---|
| | | | Low | Low | improvement | improvement |
| | | | frequency | frequency | material f0 | material f0 |
| | | | improvement | improvement | reduction | reduction |
| | | | material f0 | material f0 | value before | value after |
| | | | reduction | reduction | product | product |
| | | | value before | value after | long-term | long-term |
| | Information | Crystal | VOCs | VOCs | stability | stability |
| No. | of the example | lite size/nm | evaluation/Hz | evaluation/Hz | evaluation/Hz | evaluation/Hz |
| The first | MFI | 78 ± 3 | 240 | 18 | 115 | 34 |
| embodiment | | | | | | |
| The second | MFI | 53 ± 2 | 245 | 41 | 121 | 74 |
| embodiment | | | | | | |
| The third | MFI | 40 ± 2 | 251 | 234 | 123 | 101 |
| embodiment | | | | | | |
| The forth | MFI | 34 ± 3 | 249 | 236 | 122 | 107 |
| embodiment | | | | | | |
| The fifth | MFI | 40 ± 2 | 248 | 233 | 123 | 100 |
| embodiment | | | | | | |
| The sixth | MEL | 58 ± 2 | 243 | 23 | 121 | 35 |
| embodiment | | | | | | |
| The seventh | MEL | 54 ± 2 | 246 | 61 | 123 | 79 |
| embodiment | | | | | | |
| The eighth | MEL | 43 ± 2 | 245 | 231 | 123 | 109 |
| embodiment | | | | | | |
| The ninth | MEL/MFI | 55 ± 2 | 238 | 54 | 116 | 72 |
| embodiment | | | | | | |
| The tenth | CHA | 70 ± 3 | 202 | 201 | 102 | 98 |
| embodiment | | | | | | |
| Related art | MFI | 55 ± 2 | 244 | 46 | 120 | 78 |
| (Commercially available | | | | | | |
| Similar products) | | | | | | |

According to Table 1, it can be concluded that the small zeolite crystallites can significantly improve the stability of VOCs and the environment to use. It can be seen from the first embodiments to the ninth embodiment that the performance of the VOCs before the initial evaluation is about 240 Hz, and the initial performance in the product is about 120 Hz. There are almost no significant differences between the different embodiments. However, after the coexistence of VOCs and the stability evaluation in the product, the difference is very significant, no matter MFI structure or MEL structure, the zeolite crystallites have large loss after evaluation and poor stability; the small performance loss of zeolite crystallites is obviously smaller than that of zeolite grains. Performance loss.

In the MFI structure, the average crystallites size of the third embodiment, the forth embodiment, and the fifth embodiment 5 is between 35 and 42 nm. After the coexistence of VOCs, the low-frequency improvement performance is reduced from 248 Hz to 233 Hz, only about 15 Hz is lost, and the average grain size under the same conditions. The performance of zeolite granules in Example 1, Example 2 and prior art example 1 (commercially available products) at 78 nm to 53 nm lost more than 200 Hz; the long-term evaluation results of stability in products also corresponded to the coexistence of VOCs, and the grain size was smaller. The better the stability, the finest VOCs and stability of the zeolite of Example 4 were the best. In the MEL structure, Example 6, Example 7, and Example 8 showed an increase in average grain size, improved VOCs resistance and stability, and remained the best in Example 8 for VOCs and the best stability in the product.

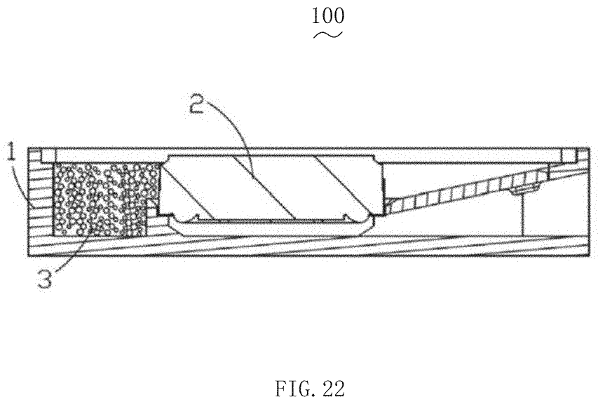

The present disclosure also provides a speaker system 100, as shown in FIG. 22. The speaker system 100 comprises a shell 1 having receiving space, a vocal monomer 2 accommodating in the shell 1, and a posterior cavity 3 which is surrounded by the vocal monomer 2 and the shell 1. The above-mentioned low-frequency improvement material is filled in the posterior cavity 3 so as to enhance the acoustical compliance of the air in the posterior cavity 3 and to improve the low-frequency performance of the speaker system.

Compared with the relevant art, for the low-frequency improvement material of the present disclosure, since the zeolite particles is ultimately composed of zeolite crystalline grains having a plurality of uniform microporous, and the microporous under the action of acoustic pressure to absorb the attached air molecules. The microporous structure of the zeolite crystalline grains can play a role in increasing the volume of the virtual acoustic cavity, while filling the zeolite crystalline grains having a plurality of uniform microporous in the posterior acvity, it can significantly improve the low-frequency effect of the speaker system and improve the low-frequency performance. Since the zeolite particles are mainly composed of zeolite crystalline grains with smaller average crystalline grain size, the smaller the average grain size, the more pores of the microporous of the zeolite particles, correspondingly, the larger the outer surface area of the zeolite particles and the shorter the diffusion path of the zeolite particles. When the same amount of organic matter is absorbed, the smoothness of the pores of the zeolite grains consisting mainly of zeolite crystalline grains is less affected. Thereby exhibiting stronger VOCs resistance, and the long-term stability in the speaker system is remarkably enhanced.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A low-frequency improvement material, comprising a plurality of zeolite particles which comprises a plurality of zeolite grains, the zeolite grains comprises a plurality of zeolite crystallites, the zeolite crystallite comprises frameworks and extra-framework cations, the skeleton comprises SiO₂ and MxOy containing element M, the average crystalline size of the zeolite crystallite ranges from 5 nm to 75 nm.

2. The low-frequency improvement material as described in claim 1, wherein the average crystallite size of the zeolite crystallites is between 15 nm and 55 nm.

3. The low-frequency improvement material as described in claim 2, wherein the average crystallite size of the zeolite crystallites is between 20 nm and 50 nm.

4. The low-frequency improvement material as described in claim 1, wherein the grain size of the zeolite grains is between 10 nm and 10 um.

5. The low-frequency improvement material as described in claim 4, wherein the grain size of the zeolite grains is between 20 nm and 8 um.

6. The low-frequency improvement material as described in claim 5, wherein the grain size of the zeolite grains is between 40 nm and 6 um.

7. The low-frequency improvement material as described in claim 6, wherein the grain size of the zeolite grains is between 400 nm and 6 um.

8. The low-frequency improvement material as described in claim 5, wherein the grain size of the zeolite grains is between 40 nm and 400 nm.

9. The low-frequency improvement material as described in claim 1, wherein the zoelite crystallite comprises at least one zeolite of the MFI structure, MEL structure, FER structure, BEA structure, and CHA structure.

10. The low-frequency improvement material as described in claim 1, wherein the molar ratio of the skeleton Si/M atom is greater than 80.

11. The low-frequency improvement material as described in claim 10, wherein the molar ratio of the skeleton between the Si/M atom 100 to 2000.

12. The low-frequency improvement material as described in claim 11, wherein the molar ratio of the skeleton between the Si/M atom 120 to 1000.

13. The low-frequency improvement material as described in claim 12, wherein the molar ratio of the skeleton between the Si/M atom 140 to 800.

14. The low-frequency improvement material as described in claim 1, wherein the element M comprises a trivalent and/or tetravalent ions.

15. The low-frequency improvement material as described in claim 14, wherein in the skeleton, the element M comprises at least one of Al, B, Ga, P, Fe, Co, Mo, Ti, Zr, Ge in species.

16. The low-frequency improvement material as described in claim 15, wherein in the skeleton, the extra-framework cations comprises at least one of hydrogen ion, alkali metal ions, alkaline earth metal ions, transition metal ions or ammonium NH4+ at least one of the radicals.

17. The low-frequency improvement material as described in claim 1, wherein the size of zeolite particles formed in the low frequency improvement material ranges from 10 um to 1000 um.

18. The low-frequency improvement material as described in claim 18, wherein the size of zeolite particles formed in the low frequency improvement material ranges from 25 um to 450 um.

19. The low-frequency improvement material as described in claim 1, wherein the size of zeolite particles formed in the low frequency improvement material ranges from 30 um to 200 um.

20. A speaker system, comprising:
a shell having a receiving space;
a vocal monomer accommodating in the shell; and
a posterior cavity which is surrounded by the vocal monomer and the shell, wherein a low-frequency improvement material as described in claim 1 is filled in the posterior cavity.
